(19) United States
(12) Patent Application Publication
(10) Pub. No.: US 2002/0002227 A1
(43) Pub. Date: Jan. 3, 2002

(54) Polymeric films having anti-static properties

(76) Inventors: James R. Porter, Lake Jackson, TX (US); William A. Koonce, Pearland, TX (US); Debkumar Bhattacharjee, Lake Jackson, TX (US); Franklin E. Parks, Jones Creek, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/824,640

(22) Filed: Apr. 3, 2001

Related U.S. Application Data
(60) Provisional application No. 60/204,873, filed on May 16, 2000.

(51) Int. Cl. C08K 3/38; C08K 3/10; C08K 3/32

(52) U.S. Cl. 524/403; 524/404; 524/406; 524/408; 524/413

(57) ABSTRACT

A process for preparing an anti-static film comprising incorporating a conductivity inducing material into a polymeric film. The conductivity inducing material is a non-volatile metal salt. The polymeric film is selected from polyurethane, polyolefins, polyvinyl chloride, nitrile rubber, polyisoprene, hydrogenated block copolymers, styrene-isoprene-styrene/styrene-butadiene-styrene block copolymers, styrene butadiene latexes, and natural rubber latex. Anti-static films and gloves prepared from such process are also disclosed.

### CROSS-REFERENCE TO PRIOR APPLICATION

This application claims the benefit of U.S. Provisional Application No. 60/204,873 filed May 16, 2000.

### BACKGROUND OF THE INVENTION

This invention relates to polymeric films and gloves, and particularly to those having anti-static properties.

For various reasons, it is desirable to provide a film or a glove which is anti-static. For example, gloves worn by persons who work with or handle electronic equipment are desirably anti-static, as anti-static gloves reduce the possibility of static discharges occurring between the worker and other objects. These static discharges are often very damaging to electronic components. In addition, certain medical applications and clean room operations require a dust-free environment. The use of anti-static gloves reduces the tendency for dust and dirt to be introduced through electrostatic attraction to the wearer.

Several attempts have been made to render elastomeric materials antistatic. For example, it is known to use topical antistatic agents such as quaternary ammonium compounds and surfactants to impart surface conductivity to polyurethane. However, these agents are quickly and easily scuffed off in applications such as shoe soles. It is also known to incorporate conductive fillers and fibers into polyurethane, but such fillers tend to alter the physical properties and processing characteristics of the polyurethane, rendering them unsuitable for the desired applications. Moreover, fillers can leach out of the elastomeric material or can shed as particulates. These fillers and fibers must also be used in relatively large quantities, which often makes them relatively expensive.

The prior art describes some antistatic compositions that do not require the use of fillers. For example, JPH5-5095 describes cast elastomers comprising a halogenated alkaline earth metal salt and polyurethane. However, JPH5-5095 does not disclose films or gloves made from such composition or the process utilized to make the antistatic composition.

In U.S. Pat. No. 5,677,357, there is disclosed an organic polymer composition stabilized against static comprising a polyurethane and an antistatically-effective amount of a hexahalogenated compound of the formula AMX6. In particular, the '357 patent describes antistatic foams, which are not necessarily suitable for gloves.

U.S. Pat. No. 5,830,541 discloses compositions stabilized against static which incorporate non-volatile metal salt conductivity inducing materials into polymers and specifically into polyurethane polymers. Such enhanced polymers are disclosed as being useful for electrostatic painting applications but not as films or gloves.

It would be desirable to provide a film and, in particular a glove which has improved anti-static properties.

### SUMMARY OF THE INVENTION

In one aspect, the present invention is a process for preparing an anti-static film comprising incorporating a conductivity inducing material into a polymeric film.

In a second aspect, the present invention is a process for preparing an anti-static film comprising dipping a former into a polymeric dispersion to form a coated former and dipping the coated former into a solution comprising a conductivity inducing material.

In a third aspect, the present invention is a process for preparing an anti-static film comprising dipping a former into a polymeric dispersion to form a film on the former, stripping the film from the former, and thereafter dipping the film into a solution comprising a conductivity inducing material.

In a fourth aspect, the present invention is a process for preparing an anti-static polyurethane film comprising admixing a polyol and a conductivity inducing material to form a polyol mixture, admixing the polyol mixture with an isocyanate to form a prepolymer, dispersing the prepolymer in water to form a polyurethane dispersion, and dipping a former into the polyurethane dispersion to form the anti-static film.

In a fifth aspect, the present invention is an anti-static film comprising a polymeric film and a conductivity inducing material incorporated into the film.

In a sixth aspect, the present invention is an anti-static glove comprising a polymeric film and a conductivity inducing material incorporated in the film.

The films and gloves of the present invention have anti-static properties and are thus suitable for, among others, medical and clean room applications.

### DESCRIPTION OF THE PREFERRED EMBODIMENTS

The polymers used to make the films of the present invention can include any polymer suitable for the desired end use. Such polymers include, for example, polyurethane, polyolefins, polyvinyl chloride, nitrile rubber, polyisoprene, hydrogenated block copolymers, styrene-isoprene-styrene/styrene-butadiene.-styrene block copolymers, styrene butadiene latexes, and other natural rubber and synthetic latexes. In a preferred embodiment, the polymer is polyurethane.

The polyurethane used to make the preferred films and gloves of the present invention is preferably an aqueous polyurethane dispersion. Such aqueous dispersion can be prepared by any method known to one of ordinary skill in the art of preparing polyurethane dispersions to be useful in making such dispersions subject to the following limitations.

The process of preparing the dispersion includes at least two steps. In a first step, a prepolymer is prepared. In a subsequent step, the prepolymer is dispersed with water.

The prepolymer can be dispersed in any way which results in a dispersion which can be used to prepare a glove having acceptable physical properties. The dispersions can be done by a batch process or by a continuous process. If done by a batch process, preferably, the dispersion in done by a phase inversion process wherein a small amount of water, including a small amount of anionic surfactant, is first added to a continuous prepolymer phase and mixed and then more water is added with mixing until the phase inverts.

When dispersions of the present invention are prepared by means of a continuous process, preferably they are prepared by means of a high internal phase ratio (HIPR) process. Such processes are known and are disclosed in, for Example, U.S. Pat. No. 5,539,021 to Pate, et al., and WO 98/41552 A1 to Jakubowski, et al. When prepared by either method, the resulting dispersion should have a particle size sufficient to make the dispersion stable. The dispersions of the present invention will have a particle size of from 0.9 to about 0.05, preferably from about 0.5 to about 0.07 and even more preferably, from about 0.4 to about 0.10 microns. Most preferably, the particle size of the dispersions of the present invention is about 0.15 microns.

The stability of the dispersion is sufficient to prevent the dispersion from coagulating under storage or shipping conditions, but not so stable that the polymer cannot be coagulated onto a substrate to prepare a film. Films are often prepared by methods that include thermal and chemical coagulation. During these processes, a dispersion at the surface of a substrate is destabilized and the polymer coalesces onto the substrate forming a film. If the dispersion is so stable that it cannot be readily coagulated onto the substrate, it is not useful for forming gloves. On the other hand, if the dispersion is so unstable that it coagulates during storage or on shipping, it is also not useful for forming the gloves of the present invention.

In a preferred embodiment, the polyurethane dispersions of the present invention are prepared from a nonionic polyurethane prepolymer. The nonionic prepolymers of the present invention are prepared with either an aliphatic or an aromatic diisocyanate. Preferably, the diisocyanate is an aromatic diisocyanate selected from the group consisting of MDI, TDI and mixtures thereof. TDI can be generally used with any commonly available isomer distribution. The most commonly available TDI has an isomer distribution of 80 percent of the 2,4 isomer and 20 percent of the 2,6 isomer. For the purposes of the present invention, TDI with other isomer distributions can also be used, but often at significantly higher cost.

When MDI is used with the formulations of the present invention, it preferably has a P,P′ isomer content of from about 99 percent to about 90 percent. Even more preferably, when MDI is used with the formulations of the present invention, it preferably has a P,P′ isomer content of from about 98 to about 92 percent. Most preferably, when MDI is used with the formulations of the present invention, it preferably has a P,P′ isomer content of about 94 percent. While MDI with such isomer distributions can be prepared by distillation during the MDI process, it can also be prepared by admixing commonly available products such as ISONATE 125M* and ISONATE 50OP*. (*ISONATE 125M and ISONATE 50OP are trade designations of The Dow Chemical Company.)

When mixtures of TDI and MDI are used to prepare the prepolymers of the present invention, they are admixed in a ratio of MDI to TDI of from about 99 percent MDI to about 80 percent MDI. More preferably, when mixtures of TDI and MDI are used to prepare the prepolymers of the present invention, they are admixed in a ratio of MDI to TDI of from about 98 percent MDI to about 90 percent MDI. Most preferably, when mixtures of TDI and MDI are used to prepare the prepolymers of the present invention, they are admixed in a ratio of MDI to TDI of about 96 percent MDI. Preferably the prepolymers of the present invention are prepared with MDI or mixtures of MDI and TDI. Even more preferably, the prepolymers of the present invention are prepared with MDI as the only aromatic diisocyanate.

In one embodiment of the present invention, the prepolymers of the present invention are prepared from a formulation that includes an active hydrogen containing material. In a preferred embodiment of the present invention, the active hydrogen containing material is a mixture of diols. One component of the diol mixture is a high molecular weight polyoxypropylene diol having an ethylene oxide capping of from 0 to 25 weight percent. The other component of the diol mixture is a low molecular weight diol. The polyether diols of the formulations of the present invention can be prepared by any method known to those of ordinary skill in the art of preparing polyether polyols to be useful for preparing such diols. Preferably, the polyether diols are prepared by the alkoxylation of a difunctional initiator in the presence of a basic catalyst. For example, a polyether useful with the present invention is a product resulting from a two step alkoxylation of ethylene glycol with first propylene oxide and then ethylene oxide, in the presence of KOH as a catalyst.

The high molecular weight polyether diol component of the diol mixture of the prepolymer formulations of present invention is preferably a polyoxypropylene diol having an ethylene oxide capping of from 0 to 25 weight percent. Preferably, the molecular weight of this component is from about 1,000 to about 4,000, more preferably from about 1,200 to about 2,500, and most preferably from about 1,800 to about 2,200. As stated, the polyether diol is capped with from 0 to 25 percent ethylene oxide. Preferably, the high molecular weight diol is capped with from about 5 to about 25 percent ethylene oxide, and more preferably, from about 10 to about 15 percent ethylene oxide.

The low molecular weight diol component of some of the prepolymer formulations of the present invention can also be a product of alkoxylating a difunctional initiator. Preferably, this component is also a polyoxypropylene diol, but it can also be a mixed ethylene oxide propylene oxide polyol, as long as at least 75 weight percent of the alkoxides used, if present, is propylene oxide. Diols such as propylene glycol, diethylene glycol, dipropylene glycol, and the like, can also be used with the formulations of the present invention. The low molecular weight diol component of the prepolymer formulations, if present, has a molecular weight of from about 60 to about 750, preferably from about 62 to about 600, and most preferably, from about 125 to about 500.

The prepolymers of the present invention can be prepared in any way known to those of ordinary skill in the art of preparing polyurethane prepolymers to useful for preparing such prepolymers. Preferably the aromatic diisocyanate and polyether diol mixture are brought together and heated under reaction conditions sufficient to prepare a polyurethane prepolymer. The stoichiometry of the prepolymer formulations of the present invention is such that the diisocyanate is present in excess. Preferably, the prepolymers of the present invention have an isocyanate content (also known as %NCO) of from about 1 to about 9 weight percent, more preferably from about 2 to about 8 weight percent, and most preferably from about 3 to about 7 weight percent.

The prepolymers of the present invention are optionally extended with a difunctional amine chain extender when the active hydrogen containing material of the prepolymer formulation is a mixture of a low molecular weight diol and a high molecular weight polyether diol. The difunctional amine chain extender is not optional but required when the active hydrogen containing material of the prepolymer formulation is a high molecular weight polyether diol and does not include a low molecular weight diol. Preferably, the difunctional amine chain extender is present in the water used to make the dispersion. When used, the amine chain extender can be any isocyanate reactive diamine or amine having another isocyanate reactive group and a molecular weight of from about 60 to about 450, but is preferably selected from the group consisting of: an aminated polyether diols; piperazine, aminoethylethanolamine, ethanolamine, ethylenediamine and mixtures thereof. Preferably, the amine chain extender is dissolved in the water used to make the dispersion.

The prepolymers of the present invention are nonionic. There are no ionic groups incorporated in or attached to the backbones of the prepolymers used to prepare the gloves of the present invention. The anionic surfactant used to prepare the dispersions of the present invention is an external stabilizer and is not incorporated into the polymer backbones of the films of the present invention.

The prepolymers of the present invention are dispersed in water which contains a surfactant. Preferably the surfactant is an anionic surfactant. In the practice of preparing the dispersions of the present invention, the surfactant is preferably introduced into water prior to a prepolymer being dispersed therein, but it is not outside the scope of the present invention that the surfactant and prepolymer could be introduced into the water at the same time. Any anionic surfactant can be used with the present invention, but preferably the anionic surfactant is selected from the group consisting of sulfonates, phophates, carboxylates. More preferably, the anionic surfactant is sodium dodecyl benzene sulfonate, sodium dodecyl sulfonate, sodium dodecyl diphenyl oxide disulfonate, sodium n-decyl diphenyl oxide disulfonate, isopropylamine dodecylbenzenesulfonate, or sodium hexyl diphenyl oxide disulfonate, and most preferably, the anionic surfactant is sodium dodecyl benzene sulfonate.

The dispersions of the present invention can have a solids level of from about 30 weight percent to about 60 weight percent. Films will not necessarily be prepared from dispersions having this level of solids. While the dispersions themselves will be stored and shipped at as high a solids content as possible to minimize storage volume and shipping costs, the dispersions can desirably be diluted prior to final use. The thickness of the film to be prepared and the method of coagulating the polymer onto a substrate will usually dictate what solids level is needed in the dispersion. When preparing films, the dispersions of the present invention can be at a weight percent solids of from 5 to about 60 percent, preferably from about 10 to about 40 percent, and, most preferably, from about 15 to about 25 weight percent when preparing examination or clean room gloves. For other glove applications, the film thickness and corresponding solids content of the dispersion used can vary.

The desired physical properties of the glove will depend largely on the end use application. For example, for an exam glove or cleanroom application, the films of the present invention can have a tensile set of less than 5%. Other properties typically measured for examination or cleanroom applications include tensile strength and elongation. Preferably, the tensile strength for examination or cleanroom gloves is at least about 2000 pounds per square inch (psi) and more preferably at least about 2500 psi. Preferably the elongation for examination or cleanroom gloves is greater than 400% and more preferably greater than 500%. Tensile strength and elongation properties are typically measured according to ASTM D-412.

To impart anti-static properties to the film or glove, a conductivity inducing material is incorporated into the film or glove. The conductivity inducing materials of the present invention are non-volatile metal salts. As a salt the conductivity inducing materials of the present invention will have both a cation and an anion. The cation of the salts can be a cation of any metal which forms an ionizable salt with one or more anions, including Li, Be, Na, Mg, Al, K, Ca, Ga, Ge, Cu, Zn, Sc, Ti, V, Cr, Mn, Fe, Co, Ni, b, Sr, In, Sn,, Sb, Y, Zr, Nb, Mo, Tc, Ru, Rh, Pd, Ag, Cd, Cs, Ba, Tl, Pb, Bi, Po, Hf, Ta, W, Re, Os, Ir, Pt, Au, Hg, Fr, Ra and the Lanthanide series of the Periodic Table of the Elements. Preferably, the cation is a cation of an alkali metal (Li, Na, K, Rb, Cs, Fr), an alkaline earth metal (Ca, Ba, Sr, Ra), Co, Ni, Fe, Cu, Cd, Zn, Sn, Al or Ag; more preferably the cation is a cation of Li, Na, K or mixtures thereof.

The anion of the non-volatile metal salt conductivity inducing material is recognizable by those skilled in the art by such characteristics as electron withdrawing groups such as halogen atoms, the possibility of resonance structures and the like. The anion is preferably a relatively large, multiatomic anion having substituents like phenyl groups, sulfur atoms, phosphorous atoms and the like that can accept and delocalize an electron charge.

Preferably the anion has at least one, more preferably more than one, even more preferably at least about 4, most preferably at least about 5, non-metallic atoms. Non-metallic atoms are generally considered to be selected from the group consisting of boron, carbon, silicon, phosphorous, arsenic, oxygen, sulfur, selenium, tellarium, fluorine, chlorine, bromine, iodine and astatine. Preferred non-metallic atoms are boron, phosphorous, sulfur, fluorine, and carbon; sulfur, phosphorous and carbon are most preferred. Preferably, the anion is selected from a tetraphenylboron anion and a hexafluorophosphate anion.

The amount of conductivity inducing material included in the polymer is an antistatically effective amount. The term “antistatically effective amount” means the amount of conductivity inducing material that is necessary to impart the required electrostatic dissipative effects to the polymeric film or glove. Preferably, the amount of conductivity inducing material in the polymeric film or glove is 0.1 to 5.0 weight percent, more preferably 0.15 to 2.0 weight percent, and even more preferably 0.2 to 1.0 weight percent, based on the weight of the final film or glove.

Desirably, the films and gloves of the present invention have the desired properties such that they are appropriate for cleanroom applications. One property important in cleanroom applications is electrostatic dissipation, commonly measured by static decay time (SDT). Preferably, the films and gloves of the present invention have an SDT of less than 5 seconds, more preferably less than 2 seconds, and even more preferably less than 0.5 seconds, as measured according to FTMS 101B method 4046 after conditioning specimens at 12% relative humidity for 48 hours. Typical test voltages applied while measuring SDT are 1000 volts or 5000 volts, more preferably 1000 volts. SDT is the measured time the applied voltage is dissipated by the film or glove specimen to 10% of the original applied voltage.

Surface resistivity is also an important characteristic for cleanroom applications. Preferably, the films and gloves of the present invention have a surface resistivity of less than 10¹³ ohms per square centimeter (Ω/cm²), and more preferably less than 10¹² Ω/cm², measured at 12% relative humidity according to ANSI/EOS/ESD S11.11 test method. Of course, the properties can vary depending upon the humidity. Electrostatic dissipation and SDT will generally be faster at a higher humidity, while resistivities will generally be lower at a higher humidity.

The gloves of the present invention can be made self releasing by inclusion of a wax during the film forming process. Preferably the wax is carnauba wax and the like. It is preferable that the wax to be used be selected from those that are not likely to induce an allergic reaction in skin that comes in contact therewith. Therefore, food grade waxes are particularly preferred for this application. When used, the waxes are preferably used as an aqueous dispersion at a concentration of from about 0.1 to about 2 weight percent.

In addition to the conductivity inducing material and the waxes already mentioned, other additives can be included in the gloves of the present invention. Any additive which is known to those of ordinary skill in the art of preparing gloves to be useful can be used with the gloves of the present invention so long as their presence does not degrade the properties of the glove. The additives can also be incorporated into the gloves in any way known to be useful including, but not limited to inclusion in the prepolymer formulation and inclusion in the water used to make the dispersion. For example useful additives include titanium dioxide, calcium carbonate, silicon oxide, defoamers, biocides, carbon particles, and the like.

To make the gloves of the present invention, the polyurethane films used to make the gloves are advantageously applied to a hand-shaped substrate using techniques which are commonly known, such as salt coagulation, thermal coagulation, casting, and combinations thereof. Coagulation processes are described generally in, for example, Japanese Kokai Feb. 1, 1990, assigned to Daiichi Kogyo Seiyaku K. K., and salt coagulation in particular is generally described in WO 96/08352, assigned to Jackson et al. Preferably, salt coagulation, also referred to herein as “dipping processes” is used to make the gloves of the present invention. A dipping process generally includes the steps of dipping a former into a bath containing a salt coagulant and removing the former; dipping the coagulant-coated former into a bath containing a dispersion of the desired polymer and removing the former; and stripping the resulting film from the former. Typically, the former will be held in air for a period of time after dipping into the polymer, in order to generate gel strength. Also, the former will typically be dipped into a leaching bath such as water before it is cooled and the film is stripped from the former.

The manner of incorporating the conductivity inducing material into the film or glove is not critical. The preferred method for incorporating the conductivity inducing material into the polymer will depend upon the conductivity inducing material used and the polymer used. For example, the conductivity inducing material can be added during the processing of the polymer, during film formation, or by a post-treatment process.

To add the conductivity inducing material to the film or glove during processing of the polymer, when the polymer is polyurethane, the conductivity inducing material can be dissolved in the polyol. The prepolymer is then formed such that the conductivity inducing material is solubilized in the prepolymer mixture. Alternatively, the conductivity inducing material can be added to the polyurethane dispersion after the dispersion is formed.

To add the conductivity inducing material to the film or glove during film formation, when dipping processes are used, a former having thereon a coagulated gel is then dipped into a solution containing the conductivity inducing material. Such dipping preferably occurs after the leaching step but before the film is cured on the former. Preferably, the former is soaked in the conductivity inducing material solution for from 5 to 30 seconds. Such dipping can be performed at room temperature, although higher temperatures can reduce the length of time needed to soak.

To add the conductivity inducing material to the film or glove utilizing a post-treatment process, the cured film is soaked in a solution containing the conductivity inducing material. Such dipping can occur while the film is still on the former or after the film has been stripped from the former. Preferably, the dipping occurs after the film has been stripped from the former, because all surfaces of the film or glove can be exposed to the salt solution. The length of time required to soak will depend upon the concentration of the salt solution. Preferably, the length of time for the soak is from 1 to 10 minutes. The soak can be performed at room temperature, although higher temperatures can be used and in fact can reduce the amount of soak time required.

The following examples are for illustrative purposes only and are not intended to limit the scope of the claimed invention. Percentages are in weight percents unless otherwise stated.

### EXAMPLES

The following materials are used in the examples below:

Polyether Polyol is a 2000 molecular weight polyoxypropylene diol having 12.5 percent ethylene oxide end capping.

Low Molecular Weight Diol is a 425 molecular weight all polyoxypropylene diol.

Polyisocyanate A is MDI having a 4,4′ isomer content of 98 percent and an isocyanate equivalent weight of 125.

Polyisocyanate B is MDI having a 4,4′ isomer content of 50 percent and an isocyanate equivalent weight of 125.

Surfactant is 22 percent solution of sodium dodecyl benzene sulfonate in water.

Diamine is a 230 molecular weight polyoxypropylene diamine.

STPB is sodium tetraphenyl boron salt.

KPF₆ is a 0.44M potassium hexafluorophosphate solution in water.

### Example 1

A polyurethane prepolymer is prepared by admixing 52.0 parts of Polyether Polyol, 0.33 parts STPB, and 14.7 parts of Low Molecular Weight Diol and then heating the admixture to 50° C. This material is then admixed with 33.3 parts of Polyisocyanate A which has also been warmed to 50° C. A small amount of benzoyl chloride is added to neutralize residual base in the polyols. The admixture is then heated at 70° C. for 4 hours and then tested to determine NCO content. The NCO content is 5.75 percent.

A polyurethane dispersion is prepared by admixing 200 g of the prepolymer admixed with 13 g water and 38 g surfactant using a high shear mixer running at about 2500 rpm. Additional water is slowly added until a phase inversion is observed. Additional water is added until the solids content is 23 percent.

A film is then prepared by a coagulation process by heating a steel plate in an oven until it reached a temperature of from 100 to 120° F. (38-49° C.). The plate is then dipped into a 20 percent solution of calcium nitrate in 1:1 by weight of water and methanol which also included about 1 wt % of a ethoxylated octylphenol surfactant. The plate is then placed into an oven at 230° F. approximately 15 minutes to form a very thin film of calcium nitate on the plate. The plate is allowed to cool to 105° F. (40° C.) and then dipped into the polyurethane dispersion diluted to 23% solids with deionized water and removed (total dwell time is approximately 20 sec). The plate is held for 5 minutes at room temperature to allow the film to generate enough gel strength, followed by leaching in a water bath at 115° F. for 10 minutes. Both sides of the plate is then sprayed with water at 115° F. (40° C.) for two additional minutes. The plate is then heated to 230° F. (110° C.) for 30 minutes and then cooled to ambient temperature. A polyurethane film is peeled from the substrate, conditioned at 12 % relative humidity and tested for static decay time (SDT) according to Federal Test Method FTMS 101B, method 4046. Results are presented in Table I.

### Example 2

Substantially the same procedure as that described in Example 1 is followed, except STPB is not added to the polyether polyol. Instead, after the polyurethane film is formed, it is post-treated by soaking in KPF₆ for 2 minutes. The film is then dried at 80° C. for 15 minutes. Test results are presented in Table I.

### Example 3

The same procedure as that described in Example 2 is followed. The film is then washed in distilled water for one hour and dried. Test results are presented in Table I.

### Example 4

Substantially the same procedure as that described in Example 2 is followed, except that the KPF6 is incorporated during film formation. After the polyurethane film has coagulated to a gel state, it is dipped into KPF₆ for 1 minute, then leached for 1 minute, and then dried at 110° C. for 45 minutes. Test results are presented in Table I.

### Comparative Example 5

Substantially the same procedure as that described in Example 1 is followed, except that no conductivity inducing material is used. Test results are presented in Table I.

TABLE I

| Example | 1 | 2 | 3 | 4 | 5 (Comparative) |
|---|---|---|---|---|---|
| SDT (seconds) | 0.95 | 0.35 | 0.55 | 0.20 | 33.0 |
| Resistivity | 8 × | 2 × 10¹¹ | 5 × 10¹¹ | 3 × | 2 × 10¹³ |
| (ohms/cm²) | 10¹¹ | | | 10¹¹ | |

What is claimed is:

1. A process for preparing an anti-static film comprising:
incorporating a conductivity inducing material into a polymeric film.

2. The process according to claim 1 wherein the conductivity inducing material is incorporated during processing of the polymer used to make the polymeric film.

3. The process according to claim 1 wherein the conductivity inducing material is incorporated during film formation.

4. The process according to claim 1 wherein the conductivity inducing material is incorporated by a post-treatment process.

5. The process according to claim 1 wherein the conductivity inducing material is a non-volatile metal salt.

6. The process according to claim 5 wherein the conductivity inducing material comprises a cation selected from the group consisting of Li, Be, Na, Mg, Al, K, Ca, Ga, Ge, Cu, Zn, Sc, Ti, V, Cr, Mn, Fe, Co, Ni, b, Sr, In, Sn,, Sb, Y, Zr, Nb, Mo, Tc, Ru, Rh, Pd, Ag, Cd, Cs, Ba, Tl, Pb, Bi, Po, Hf, Ta, W, Re, Os, Ir, Pt, Au, Hg, Fr, Ra and the Lanthanide series of the Periodic Table of the Elements.

7. The process according to claim 5 wherein the conductivity inducing material comprises an anion having at least one non-metallic atom selected from the group consisting of boron, carbon, silicon, phosphorous, arsenic, oxygen, sulfur, selenium, tellarium, fluorine, chlorine, bromine, iodine and astatine.

8. The process according to claim 1 wherein the polymer is selected from the group consisting of polyurethane, polyolefins, polyvinyl chloride, nitrile rubber, polyisoprene, hydrogenated block copolymers, styrene-isoprene-styrene/styrene-butadiene-styrene block copolymers, styrene butadiene latexes, and natural rubber latex.

9. The process according to claim 8 wherein the polymer is an aqueous polyurethane dispersion.

10. An anti-static glove prepared according to the process of claim 1.

11. A process for preparing an anti-static film comprising:
dipping a former into a polymeric dispersion to form a coated former; and
dipping the coated former into a solution comprising a conductivity inducing material.

12. The process according to claim 11 wherein the former is in the shape of a hand.

13. A process for preparing an anti-static film comprising:
dipping a former into a polymeric dispersion to form a film on the former;
stripping the film from the former; and thereafter dipping the film into a solution comprising a conductivity inducing material.

14. The process according to claim 13 wherein the former is in the shape of a hand.

15. A process for preparing an anti-static polyurethane film comprising:
admixing a polyol and a conductivity inducing material to form a polyol mixture;
admixing the polyol mixture with an isocyanate to form a prepolymer;
dispersing the prepolymer in water to form a polyurethane dispersion; and
dipping a former into the polyurethane dispersion to form the anti-static film.

16. The process according to claim 15 wherein the former is in the shape of a hand.

17. An anti-static film comprising:
a polymeric film; and
a conductivity inducing material incorporated into the film.

18. The anti-static film according to claim 17, wherein the polymeric film comprises an polymer selected from the group consisting of polyurethane, polyolefins, polyvinyl chloride, nitrile rubber, polyisoprene, hydrogenated block copolymers, styrene-isoprene-styrene/styrene-butadiene-styrene block copolymers, styrene butadiene latexes, and natural rubber latex.

19. The anti-static film according to claim 17 wherein the conductivity inducing material is a non-volatile metal salt.

20. The anti-static film according to claim 19 wherein the conductivity inducing material comprises a cation selected from the group consisting of Li, Be, Na, Mg, Al, K, Ca, Ga, Ge, Cu, Zn, Sc, Ti, V, Cr, Mn, Fe, Co, Ni, b, Sr, In, Sn,, Sb, Y, Zr, Nb, Mo, Tc, Ru, Rh, Pd, Ag, Cd, Cs, Ba, Tl, Pb, Bi, Po, Hf, Ta, W, Re, Os, Ir, Pt, Au, Hg, Fr, Ra and the Lanthanide series of the Periodic Table of the Elements.

21. The anti-static film according to claim 19 wherein the conductivity inducing material comprises an anion having at least one non-metallic atom selected from the group consisting of boron, carbon, silicon, phosphorous, arsenic, oxygen, sulfur, selenium, tellarium, fluorine, chlorine, bromine, iodine and astatine.

22. An anti-static glove comprising:
a polymeric film; and
a conductivity inducing material incorporated in the film.

23. The anti-static glove according to claim 22, wherein the polymeric film comprises an polymer selected from the group consisting of polyurethane, polyolefins, polyvinyl chloride, nitrile rubber, polyisoprene, hydrogenated block copolymers, styrene-isoprene-styrene/styrene-butadiene-styrene block copolymers, styrene butadiene latexes, and natural rubber latex.

24. The anti-static glove according to claim 22 wherein the conductivity inducing material is a non-volatile metal salt.

25. The anti-static glove according to claim 24 wherein the conductivity inducing material comprises a cation selected from the group consisting of Li, Be, Na, Mg, Al, K, Ca, Ga, Ge, Cu, Zn, Sc, Ti, V, Cr, Mn, Fe, Co, Ni, b, Sr, In, Sn,, Sb, Y, Zr, Nb, Mo, Tc, Ru, Rh, Pd, Ag, Cd, Cs, Ba, Ti, Pb, Bi, Po, Hf, Ta, W, Re, Os, Ir, Pt, Au, Hg, Fr, Ra and the Lanthanide series of the Periodic Table of the Elements.

26. The anti-static glove according to claim 24 wherein the conductivity inducing material comprises an anion having at least one non-metallic atom selected from the group consisting of boron, carbon, silicon, phosphorous, arsenic, oxygen, sulfur, selenium, tellarium, fluorine, chlorine, bromine, iodine and astatine.
